(19) United States
(12) Patent Application Publication
(10) Pub. No.: US 2010/0191831 A1
(43) Pub. Date: Jul. 29, 2010

(54) UBIQUITOUS PRESENCE METHOD AND SYSTEM FOR PROVIDING 3A BASED VARIOUS APPLICATION STATUSES

(75) Inventors: Jeong-Hun Moon, Seongnam-si (KR); Taeksoo Kim, Gunpo-si (KR); Sung Jae Jang, Yongin-si (KR); Kyungyong Kim, Seongnam-si (KR); Sang-Yun O, Suwon-si (KR)

Correspondence Address: H.C. PARK & ASSOCIATES, PLC, 8500 LEESBURG PIKE, SUITE 7500, VIENNA, VA, 22182, US

(73) Assignee: NHN Corporation, Seongsam-si (KR)

(21) Appl. No.: 12/663,970

(22) PCT Filed: Jun. 20, 2008
(86) PCT No.: PCT/KR2008/003540

§ 371 Date: Dec. 10, 2009

(30) Foreign Application Priority Data
Jun. 20, 2007 (KR) 10-2007-0060202

(51) Int. Cl. G06F 15/16

(52) U.S. Cl. 709/219; 709/226

(57) ABSTRACT

A ubiquitous presence service method and system is disclosed, wherein the list of subscribers is managed in the replay platform, and the presence of each service from the application server is integrated through one route, and is then integrally managed so that they are provided based on 3A anytime, anywhere and regardless of the device, whereby the subscriber who receives the information about the present status of the application services operated by the various application servers can integrally manage his(her) own presence profiles, and the application server can provide the subscription authorities of the presence service to the consistent interface. The ubiquitous presence service method comprises receiving presence information including a present or updated status of application service from one or more application servers; and transmitting the received presence information to at least one subscriber terminal.

### CROSS-REFERENCE TO RELATED APPLICATIONS

This application is the National Stage of International Application No. PCT/KR2008/003540, filed Jun. 20, 2008, and claims priority from and the benefit of Korean Patent Application No. 10-2007-0060202, filed on Jun. 20, 2007, which are both hereby incorporated by reference for all purposes as if fully set forth herein.

### BACKGROUND OF THE INVENTION

1. Field of the Invention

The present invention relates to a presence service method and system, and more particularly, to a ubiquitous presence service method and system for providing 3A (Anytime, Anywhere, Any device)-based present statuses and update information (presence information) of application services operated by various application servers.

2. Discussion of the Background

FIG. 1 illustrates a related art presence service method. Referring to FIG. 1, a user terminal such as a desktop computer, a notebook computer, a cellular phone, and a PDA (personal digital assistant) can make an access to various sets of information provided by application servers through networks such as the Internet, public networks, mobile Internet networks, or mobile communication networks. In addition, the application servers can provide a subscriber with both presence about an online status, geographical location or service availability of the user terminal, and various services using the presence such as a location-based service or a messenger service. Currently, the subscriber can be provided with the presence such as various information (for example, the present or updated status of specific information provided by the corresponding application) about the present status of the application services.

If a user wants to use the presence service, the user firstly has to register in a homepage, online community or blog operated by the application server through the use of the user terminal, whereby the user can get selectively notified only of the necessary presence from a huge amount of information updated by the application servers at any time.

However, in the case of the related art presence service, the user should perform the registration of presence service, and the change, addition and deletion related with the registration of presence service through the access to each application such as the homepage, online community or blog provided by the application server. Accordingly, the related art presence service is problematic in that it is difficult to manage presence-related profiles integrally.

Also, the application server can grant the user an authority for subscription by separately processing the change, addition and deletion of each user registration related with the presence notification. That is, the authority for subscription related with the presence notification in each application can not be provided through an integrated interface, which is problematic.

In the meantime, the existing presence service on the Internet has been provided through a high-speed Internet line using a fixed computer. However, according as the society recently moves to a ubiquitous era, such services are starting to be provided through various ubiquitous devices, and ubiquitous services are provided anytime and anywhere not only through a personal computer, a cellular phone and a PDA, but also through various devices such as a terminal that supports wireless Internet or mobile Internet, a refrigerator connected to a LAN (Local Area Network), a microwave oven, an electric rice-cooker, an automatic vending machine and a memory stick. Ubiquitous services are proactive services where services approach a customer rather than the customer approaches the services.

Accordingly, greeting the ubiquitous era, there is a need for an infrastructure for easily and efficiently delivering the presence generated by each application service such as the Internet to individual customers by integrating the presence, and because it is practically difficult for the application server to provide various types of ubiquitous devices for each service, there is a need for a relay platform for appropriately processing the presence in accordance with the device.

### SUMMARY OF THE INVENTION

Therefore, the present invention has been made in view of the above problems, and it is an object of the present invention to provide a ubiquitous presence service method and system, wherein the list of subscribers is managed in the relay platform, and the presence of each service from the application server is integrated through one route, and is then integrally managed so that they are provided based on 3A anytime, anywhere and regardless of the device, whereby the subscriber who receives the information about the present status of the application services operated by the various application servers can integrally manage his\her own presence profiles, and the application server can provide the subscription authorities of the presence service to the consistent interface.

Another object of the present invention is to provide a ubiquitous presence service method and system, wherein an appropriate broker connection for supporting a data format registered by the application server, a UI (User Interface) logic linked with a predetermined contents gateway, or an asynchronous transmission processor is operated so that any type of ubiquitous user terminal can receive the presence service by a communication method appropriate to the corresponding user terminal.

Another object of the present invention is to provide a ubiquitous presence service method and system, wherein such technologies are implemented through small modifications of the existing legacy service, so an integrated presence service appropriate for ubiquitous devices can be provided, and ubiquitous connection rings that can be more closely adhered to the service can be provided to the user, thereby significantly contributing to the development of the service itself.

To achieve these objects and other advantages and in accordance with the purpose of the invention, as embodied and broadly described herein, a ubiquitous presence service method comprises receiving presence information including a present or updated status of an application service from one or more application servers; and transmitting the received presence information to at least one subscriber terminal.

In another aspect of the present invention, a ubiquitous presence service method comprises integrating presence information for each application service operated by an application server using a relay platform between the application server and various types of ubiquitous terminals through one route, and integrally managing the presence information; and transmitting the presence information of data format supported by the corresponding terminal to at least one of the terminals registered for a subscription of the presence service to at least one part of the presence information desired to receive.

In another aspect of the present invention, a ubiquitous presence service system comprises a presence gateway configured to receive presence information including information about a present or updated status of an application service; and a presence transmitting unit configured to relay the received presence information. At this time, the presence transmitting unit distinguishes various types of each subscriber terminal, and transmits the presence information using a communication method supported by the corresponding subscriber terminal.

### BRIEF DESCRIPTION OF THE DRAWINGS

FIG. 1 illustrates a related art presence service method.

FIG. 2 illustrates a ubiquitous presence service system according to an embodiment of the present invention.

FIG. 3 illustrates one example of log-in information to be provided as presence information according to an embodiment of the present invention.

FIG. 4 illustrates one example of pop-up information to be provided as presence information according to an embodiment of the present invention.

FIG. 5 illustrates one example of online community widget information to be provided as presence information according to an embodiment of the present invention.

FIG. 6 illustrates one example of online community bulletin information to be provided as presence information according to an embodiment of the present invention.

FIG. 7 illustrates a detailed block diagram of a ubiquitous presence server of FIG. 2.

FIG. 8 illustrates one example of a presence transmitting unit of FIG. 7 embodied in a UnotS (ubiquitous notification service).

FIG. 9 illustrates one example of a presence transmitting unit of FIG. 7 embodied in a UCG (ubiquitous contents gateway).

FIG. 10 illustrates a flow chart for explaining a ubiquitous presence service method according to an embodiment of the present invention.

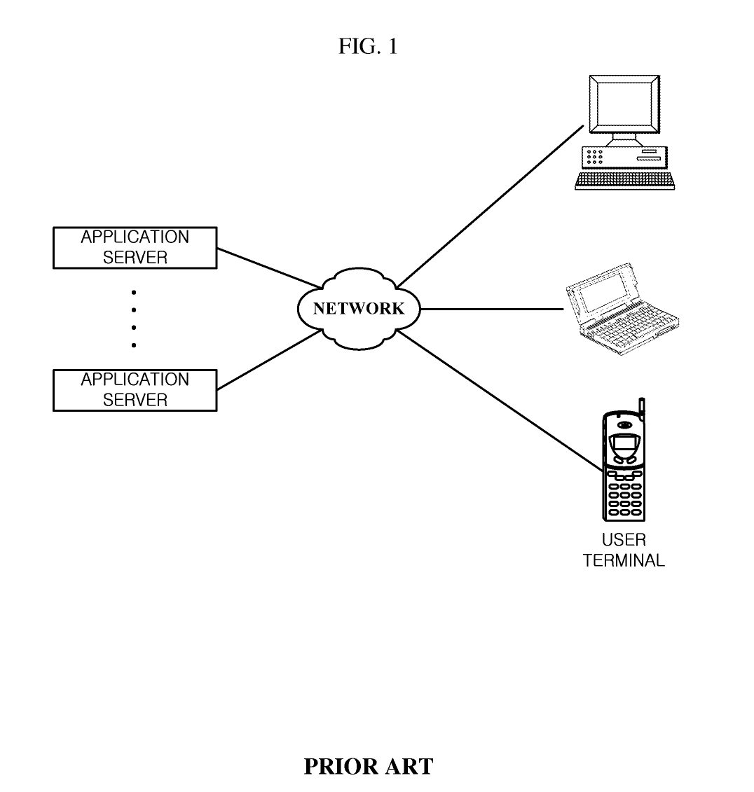

### DETAILED DESCRIPTION OF THE ILLUSTRATED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Hereinafter, a ubiquitous presence method and system according to the present invention will be described with reference to the accompanying drawings.

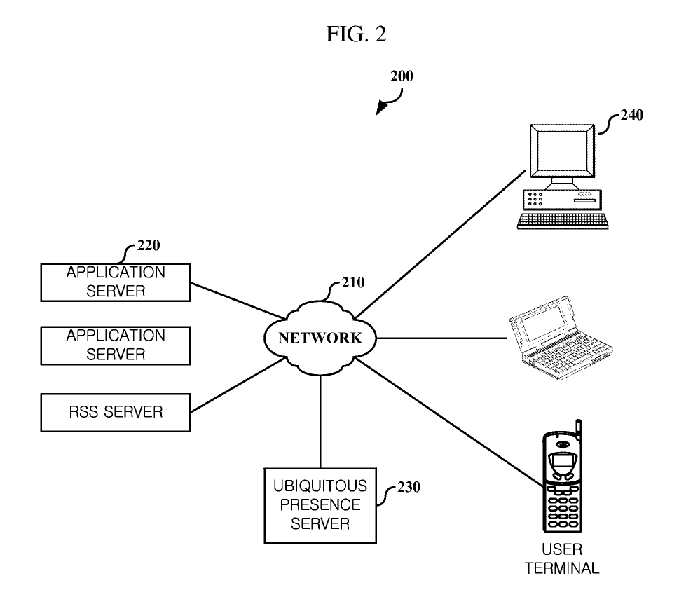

FIG. 2 illustrates a ubiquitous presence service system according to an embodiment of the present invention. Referring to FIG. 2, the ubiquitous presence service system 200 according to an embodiment of the present invention includes one or more application servers 220 connected to a network 210 such as Internet, wireless Internet network, mobile Internet network, or core network; user terminals 240 corresponding to various types of ubiquitous devices; and a ubiquitous presence server 230 serving as a platform to relay presence information from the application server 220 to the user terminal 240. In this case, the application server 220 includes an RSS (Really Simple Syndication) server, wherein the RSS server enables a subscriber to check frequently updated contents with easiness. If the subscriber periodically makes an access to the RSS server in a specific site, and collects RSS files, the title and summary of updated contents is automatically provided to the subscriber.

The application server 220 provides various application services to the user. The application services may include a homepage managing service; a messaging service such as a messenger service, an e-mail service and an SMS (Short Message Service); a notice service; an emergency rescue service; a community notice service; and an information providing service for providing securities/finance information, online community information, blog information, game information, etc. Especially, the application server 220 can operate the application service which provides only presence information useful to the subscriber, so that the subscriber can be provided with the updated present status.

The presence information includes the present status of the application service provided to the subscriber whenever the information is updated with the change of status, and also includes the information about the updated status. The application service for providing the presence information may include various services, for example, log-in information of homepage, pop-up information, widget information, online community bulletin information, received e-mail notifying information, information about new writings or comments in a blog, auctions related with finance/electronic commercial transactions, stock price information, account information, broadcasting-related program information, sports hook-up, home shopping information, local information-related profile, weather forecast, coupons, real estate information, communication-related absence information, VoIP message, call charge information, personal schedule information, interested acquaintance information, etc.

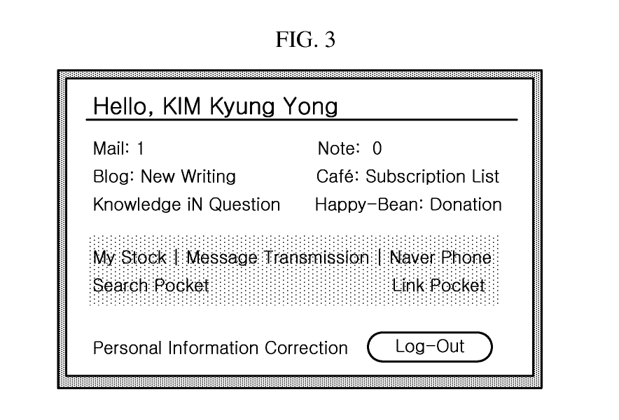

For example, the application server 220 may provide the application information related with the user, for example, log-in information of Naver Homepage, as shown in FIG. 3, as the presence information. The application information to be the presence service may include the number of received e-mails, the number of notes, and the information about the blog or online community subscribed by the user. The application information to be the presence service may be a partial portion of corresponding user's browser or an entire screen, or a specific meaning in the screen, that is, updated portion (the number of received e-mails, the number of notes, etc.). In all cases, the corresponding application information to be the presence service can be managed in correspondence with location information based on URL (Uniform Resource Locator).

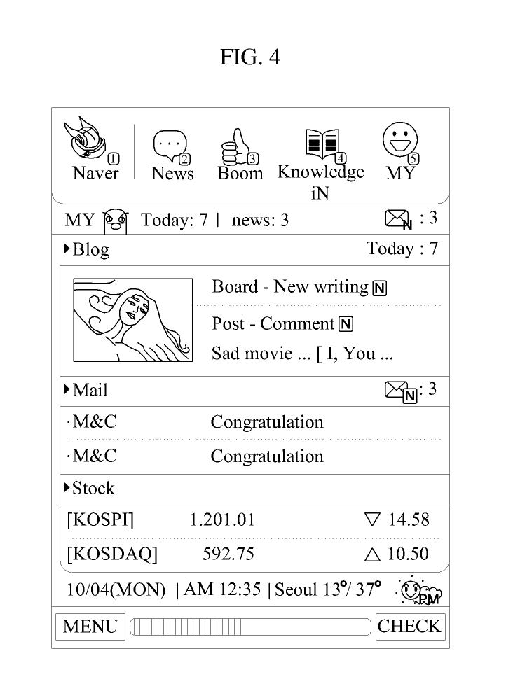

FIG. 4 illustrates one example of pop-up information to be provided as presence information according to an embodiment of the present invention. As shown in FIG. 4, the application server 220 can manage a partial or entire screen of pop-up information, or a specific meaning in the screen (for example, the number of e-mails, the number of comments, the stock price, etc.), which is made by collecting the information frequently searched by the user and providing the collected information in a real-time pop-up format, as the application information to be the presence service at a predetermined location based on URL.

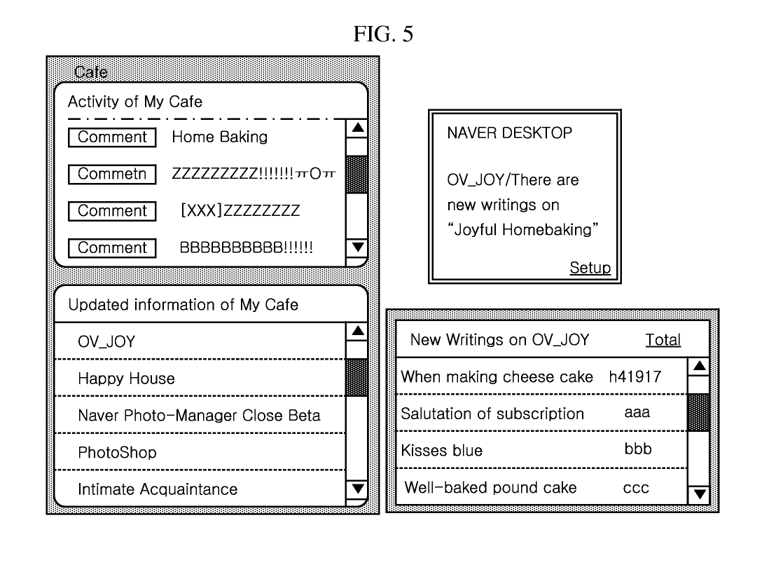

In addition, as shown in FIG. 5, a partial or entire screen for pop-up information updated with the change of status, or a specific meaning in the screen, for example, activity or updated news about online community, new writings on the online community, and event news to notify new writings written on the online community, can be managed as the application information to be the presence service.

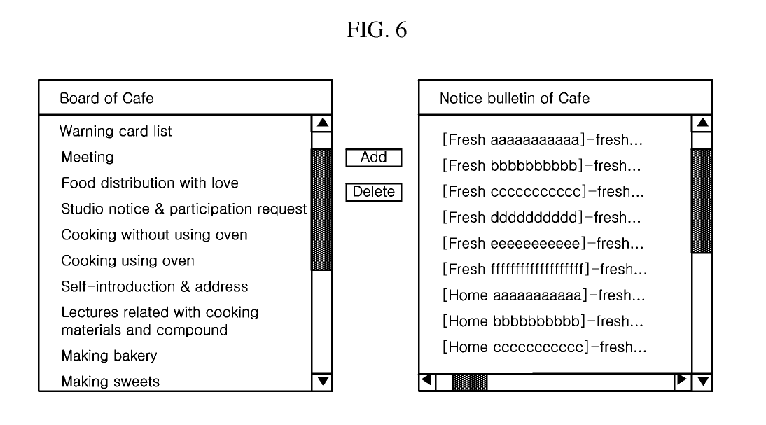

Also, as shown in FIG. 6, a partial or entire screen for pop-up information updated with the change of status, or a specific meaning in the screen, for example, the present status of online community or notice writings on a bulletin of the online community, can be managed as the application information to be the presence service at a predetermined location based on URL.

Also, the application service to be the presence service may include MO (Mobile Origination)-based service which is updated in accordance with the information uploaded from the user terminal 240, for example, general data or multi-media contents such as images, moving pictures, and music files.

The user terminals 240, which are various types of ubiquitous devices, include a computer such as a desktop computer and a notebook computer, and a mobile terminal such as a cellular phone that uses Code Division Multiple Access/Wideband Code Division Multiple Access CDMA/WCDMA network, wireless Internet or mobile Internet, a PCS phone (Personal Communications Services phone) and synchronous/asynchronous IMT-2000 (International Mobile Telecommuncation-2000). The user terminals 240 can also include all types of wire/wireless electronic/communication devices such as a Palm PC (Palm Personal Computer), a PDA (Personal Digital Assistant), a smart phone, a WAP phone (Wireless Application Protocol phone), a mobile play-station, a TV connected to the public network or IP network, or connected to LAN, an IPTV, a refrigerator and a microwave oven.

The ubiquitous presence server 230 serves as the platform to relay the presence information from the application server 220 to the various types of user terminals 240. The ubiquitous presence server 230 integrates the presence information (for example, including the information about the present or updated status of the application service related with the real-time stock price, the number of unread e-mails, whether there are the new writings in the blog, the title of new writings, the status of notice writings on the bulletin, and the uploaded contents) for the operated application service through one route; manages the integrated presence information; and transmits the presence information of data format (XML, HTML, WAP, binary format, etc.) supported by the corresponding user terminal to at least one of the user terminals subscribed for at least part of the presence information in a communication method (TCP/IP, SMS, UDP, P2P, etc.) supported in the corresponding user terminal.

Registration authorities about the presence service linked with the application server 220 are granted through the ubiquitous presence server 230; and the user using the various types of ubiquitous devices (terminals) such as a computer, a mobile terminal, a TV, a PDA and a game machine can participate in the registration procedure for receiving the presence service through the ubiquitous presence server 230 anytime and anywhere, and can be provided with the presence service.

The list of subscribers who desire to receive the presence service is managed not in the application server 220 but in the ubiquitous presence server 230 serving as the relay platform. Accordingly, the application server 220 can provide the registration authorities of the presence service to the consistent interface of the ubiquitous presence server 230.

Also, the presence information about each service from the application server 220 is integrated in the ubiquitous presence server 230 through one route, and is then integrally managed, so that the subscriber can integrally manage his\her own presence profiles through the ubiquitous presence server 230, and the ubiquitous presence server 230 can provide the presence information to the subscribers based on 3A in a manner that is appropriate to the device. As a result, a ubiquitous connection ring, which can be closely adhered to the service, is provided to the user. Such a ubiquitous presence server 230 can be implemented by only a little modification of a legacy service such as a push-type presence or event service provided by the application server 220 operating the application for the service.

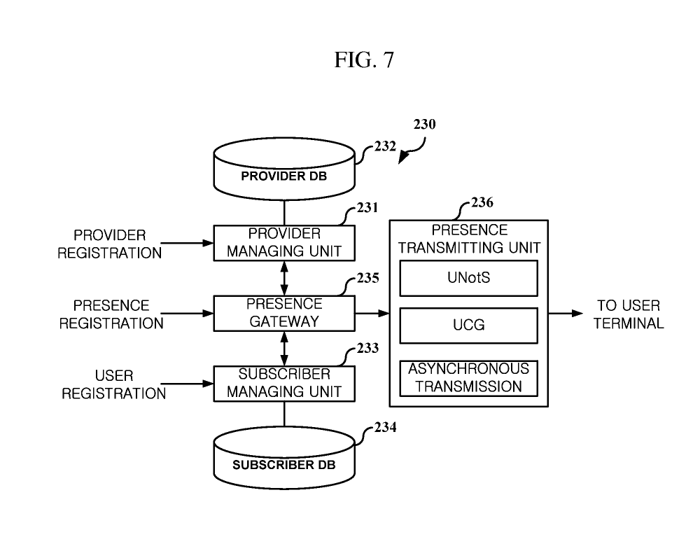

FIG. 7 illustrates a detailed block diagram of the ubiquitous presence server 230 of FIG. 2. Referring to FIG. 7, the ubiquitous presence server 230 includes a provider managing unit 231, a provider DB (database) 232, a subscriber managing unit 233, a subscriber DB 234, a presence gateway 235, and a presence transmitting unit 236.

The provider managing unit 231 receives provider information including a location list of the application information to be the presence service from the application server 220 which operates the application service whose status is updated; and registers the received provider information in the provider DB 232. The location list such as URL of the corresponding service is stored in the provider DB 232, wherein the location list can be stored in correspondence with service ID and presence ID.

According to a request from the user terminal 240, the subscriber managing unit 233 transmits the location list of the application information to be the presence service registered by the application server 220 to the user terminal 240. In this case, the subscriber managing unit 233 transmits the corresponding user ID to the application server 220, whereby the application server 220 can perform the registration procedure after checking the corresponding user's authentication.

The authenticated user terminal transmits selection information about at least one location selected by the user from the location list provided in the subscriber managing unit 233, and user information such as the user ID, password, unique terminal number and terminal model to the subscriber managing unit 233. Thus, the subscriber managing unit 233 registers subscriber information inclusive of the selection information and user information in the subscriber DB 234 by each subscriber.

If the service subscriber's authorities for a certain channel are changed or disappear, the application server 220 should inform the subscriber managing unit 233 of the fact using the deregistration command for the corresponding location of the subscriber. Thus, the subscriber managing unit 233 removes the subscriber authorities from the subscriber DB 234 so that the presence-related message is not transmitted to the corresponding subscriber terminal.

In the meantime, the presence gateway 235 receives the presence information updated in the location list register by the provider DB 232 from the application server 220. In an embodiment of the present invention, the presence gateway 235 can receive the presence information using data format such as XML (eXtensible Markup Language), HTML (Hyper Text Markup Language), WAP (Wireless Application Protocol), etc. In the modified embodiment of the present invention, the presence gateway 235 may receive only specific meaning in a manner according to a binary protocol, or may use adaptation layers such as HTTP (Hyper Text Transfer Protocol) and JAVA Class to support the corresponding binary protocol.

The application server 220 connected to the presence gateway 235 should be a server registered in the provider DB 232 by the provider managing unit 231, and can be connected based on the service ID or authentication key when trying to be connected. After that, all presence information transmitted from the application server 220 are transmitted to the corresponding transmitting means of the presence transmitting unit 236 for the transmission to the user terminal 240 according to rules stipulated in the presence gateway 235.

The presence transmitting unit 236 relays the presence information provided from the presence gateway 235 to the subscriber terminal. The presence transmitting unit 236 transmits the presence information about the present or updated status of the application information to be the presence service to the corresponding subscriber terminal at the corresponding location registered by the subscriber according to the information of each subscriber in the subscriber DB 234.

The presence transmitting unit 236 can transmit the updated presence information to the subscriber terminal whenever the presence information is updated, but it is not limited to this. For example, even though the presence information is not updated, the present status of the application information may be periodically transmitted to the subscriber terminal every dawn with less traffic. To support the various types of subscriber terminals, the presence transmitting unit 236 can transmit the presence information in a communication method supported by the corresponding terminal, after dividing various types of each subscriber terminal.

First, the presence transmitting unit 236 may transmit the presence information to the corresponding terminal by an asynchronous transmission method through the use of asynchronous transmission means. The asynchronous transmission method inserts data of predetermined length into a predetermined period from a start pulse to a terminate pulse (for example, data corresponding one letter), and then transmits the data. In consideration of the fact that a communication network resource can be differently allotted according to the status of the ubiquitous user terminal 240, the asynchronous transmission method may be one method which can appropriately transmit the corresponding data according to the user's request.

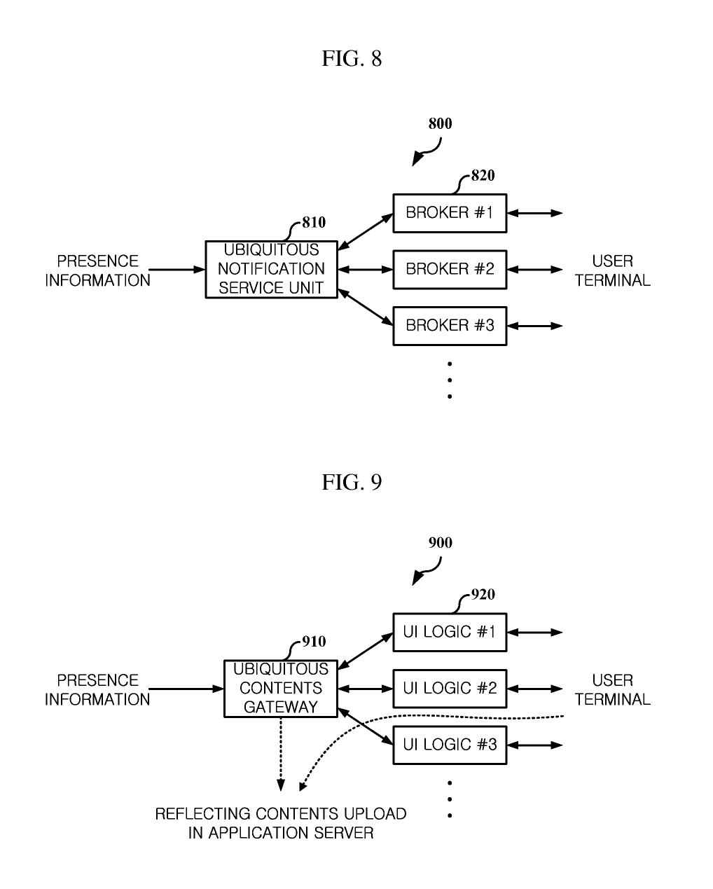

The presence transmitting unit 236 of FIG. 7 may be comprised of the UnotS (Ubiquitous Notification System) of FIG. 8. Referring to FIG. 8, a presence transmitting unit 800 according to an embodiment of the present invention includes a ubiquitous notification service unit 810, and one or more brokers 820.

If the presence information provided from the presence gateway 235 is the preset data format, the ubiquitous notification service unit 810 can receive the presence information of the preset data format. Also, one or more brokers 820 divide the subscriber terminals into various types, and transmit the presence information in the communication method supported by the corresponding subscriber terminal. Among the brokers, the broker 820 supporting the transmission of the corresponding data format can transmit the presence information to the subscriber terminal in the communication method supported by the corresponding subscriber terminal.

In an embodiment of the present invention, each broker 820 can support the transmission of presence information to the various ubiquitous devices by transmitting the presence information in the various communication methods appropriate to the terminals such as TCP/IP (Transmission Control Protocol/Internet Protocol), SMS (Short Message Service), UDP (User Datagram Protocol), and P2P (Peer to Peer).

The connection between the corresponding presence information and the user terminal 240 can secure the uppermost performance in connection with the transmission of presence information to the terminal through a pointer reference in a predetermined memory. In the case of the same presence information distributed to a multiple of subscriber terminals by means of one broker 820, the ubiquitous notification service unit 810 can transmit the presence information transmitted from the presence gateway 235 and the list of user terminals to be provided with the corresponding presence information to the broker 820; and the broker 820 can distribute the corresponding presence information to each subscriber terminal.

Further, the broker 820, which supports various forms of communication according to the type of the user terminal 240, may be largely classified into connection-based brokers and non-connection-based brokers. The connection-based broker considers connected and authenticated user terminals 240 as valid clients; activates the presence signal being connected to the presence gateway 235; and transmits the presence information transmitted from the presence gateway 235 to the corresponding subscriber terminals.

The non-connection-based broker is used in an SMS-based mobile terminal, or an Internet service terminal of a periodic polling method for a pop-up service. In this case, session information is separately managed in the broker 820. For example, a mobile phone can be considered as an Always-On Device (it is always in an on-state), so it can be considered that the subscription and cancellation of the service correspond to the log-in and log-out of an Internet website. However, it is possible to store subscriber information, which is information about some user terminals intending to receive the presence information among the user terminals 240, in the subscriber DB 234 through the subscriber managing unit 233. In addition, it is possible to operate a separate DB for integrally managing the presence (on/off state) of the corresponding subscriber terminals in the broker 820. The broker 820 can be developed continuously, and can be added in line with the service support method of the terminal depending on the type of device to be added.

In the meantime, the broker 820 can transmit the presence information in XML-type data without dividing various forms of the subscriber terminal depending on the necessity, but it is desirable to transmit the presence information after including the specific meaning in a payload (data) according to the binary protocol of the data format supported by the corresponding terminal in consideration of various forms of each subscriber terminal.

For this, the application server 220 can define the binary protocol about the corresponding presence information in the ubiquitous notification service unit 810; register UED (UnotS Event Description) such as the following [UED algorithm]; and generate the presence information about the corresponding binary protocol.

[UED algorithm]

<?xml version=“1.0” encoding=“euc-kr” ?>
<ued event-provider-id=“[eventProviderID]” event-id=“[eventID]”>
<description>[brief description]</description>
<record>
<field name=“[name]” type=“[data type]” />
[repeat field element]
</record>
<url>[additional information URL]</url>
<template>[template to be displayed on the screen]</template>
</ued>

At this time, the data format provided to describe the binary protocol can be defined as an integer such as 8, 16 and 32 bits or a character string function, and can be transmitted and received, as shown in the following [Table 1], so that they can be easily adapted to the various subscriber terminals.

In the case of multimedia data such as images or video files transmitted in the above data type, it is possible to transmit encoded data by utilizing functions such as String2 or String4. However, in the case of such multimedia data, it is desirable to encode only the URLs (Uniform Resource Locator) in the message, and transmit the encoded URLs. Herein, the subscriber terminal analyzes the corresponding presence information, and is provided with the multimedia content using the server connection through the URL. For this, the ubiquitous notification service unit 810 can transmit the UED file for the user interface to the subscriber terminal according to the request of the subscriber terminal; the broker 820 can transmit the presence information according to the binary protocol of the data format designated in the UED file; and the subscriber terminal can convert the presence information in a form based on a template by parsing the UED file.

TABLE 1

| Data type | Explanation |
|---|---|
| U8 | integer between 0 and 255 |
| I8 | integer between −128 and 127 |
| U16 | integer between 0 and 65535 |
| I16 | integer between −32768 and 32767 |
| U32 | integer between 0 and 4294967926 |
| I32 | integer between −2147483648 and 2147483647 |
| String1 | character string within 255 |
| | (initial 1-byte is length, and the following is character string) |
| String | character string within 65535 |
| | (initial 1-byte is length, and the following is character string) |

FIG. 9 illustrates one example of the presence transmitting unit 236 of FIG. 7 embodied in a UCG (Ubiquitous Contents Gateway). Referring to FIG. 9, a presence transmitting unit 900 according to another embodiment of the present invention includes a ubiquitous contents gateway 910, and one or more user interface (UI) logics 920.

The ubiquitous contents gateway 910 receives the presence information, and determines the data format of the subscriber terminal to be provided with the corresponding presence information, with reference to the subscriber DB 234. Thus, one or more UI logics 920 transmit the presence information to the ubiquitous subscriber terminal. For example, the ubiquitous contents gateway 910 can select any one UI logic supporting the transmission of data format to the subscriber terminal from the UI logics, according to the determination result. After that, the selected UI logic converts the presence information into the data format supported by the corresponding subscriber terminal, for example, XML, HTML, WAP, binary format, etc., whereby the data converted based on the communication method (TCP/IP, SMS, UDP, P2P, etc.) of the corresponding subscriber terminal is transmitted to the corresponding subscriber terminal.

Also, the presence transmitting unit 900 can upload the MO-based contents provided from each ubiquitous subscriber terminal. That is, when the user terminal 240 uploads the general data or multimedia data such as the music file, image, and moving pictures to the application server 220, the corresponding data can be received through any one of the UI logics 920 according to the corresponding data format, and the received data can be uploaded to the application server 220 through the ubiquitous contents gateway 910.

In the meantime, the user terminal 240 may include the predetermined client which supports the registration procedure for subscription of the presence service, and the user interface; and may include a template parser for parsing the UED file.

The client included in the user terminal 240 can transmit the subscription request to subscribe to the presence service operated by the ubiquitous presence server 230; and can transmit the UED request for the download of the UED file. Also, the client can receive the location list of the application information to be the presence service of the application server 220 from the provider managing unit 231; select at least any one location from the location list; generate the subscriber information including the selection information about the selected location and the user information (user ID, password, terminal serial number, terminal mode, etc.) about the user terminal; and transmit the generated subscriber information to the subscriber managing unit 233 of the ubiquitous presence server 230.

Accordingly, when the subscriber managing unit 233 registers the subscriber information in the subscriber DB 234, the client can receive the presence information about the corresponding location according to the selection information, for example, the present or updated status of service such as the real-time stock price, the number of unread e-mails, the new writings or comments in the blog, the title of new writing or comments, the notice writing in the bulletin, and the uploaded contents.

The received presence information is displayed through the user interface of the user terminal 240. Especially, the client can directly raise the received XML-type presence information to the upper application for displaying the message, or can apply the received presence information to the template included in the UED file for displaying the message. For this, the template parser of the user terminal 240 extracts and analyzes a template that designates a presence display form by parsing the UED file. Accordingly, the user interface of the terminal can display the presence information according to the binary protocol in a form applied in the template. This can be utilized in the case of a service that provides a simple alerting function.

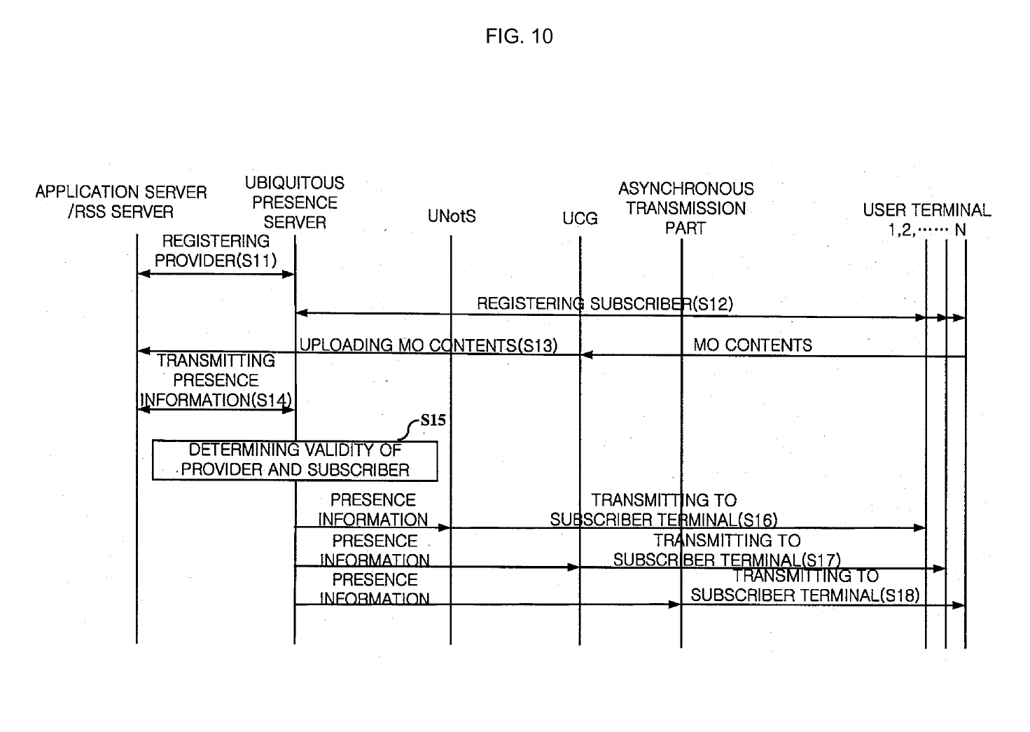

An operation of the ubiquitous presence server 230 according to an embodiment of the present invention will be explained with reference to FIG. 10.

First, in order to provide the presence service according to the relay platform of the ubiquitous presence server 230, the application server 220 operating the application information to be the presence service, for example, RSS server, registers the location list of the corresponding application information including the service ID or presence ID as the provider information (S11). At this time, the ubiquitous notification service unit 810 may store the XML-type UED file supported by the corresponding application server 220. The provider managing unit 231 of the ubiquitous presence server 230 stores and manages the provider information in the provider DB 232. For utilizing the ubiquitous notification service unit 810, the UED file may be managed such that the UED file is mapped to the corresponding application information.

Next, in order to be provided with the presence service by the application server 220, the user terminal 240 can transmit the subscription request of the presence service to the subscriber managing unit 233 of the ubiquitous presence server 230 (S12). Accordingly, when the subscriber managing unit 233 transmits the location list of the application information to be the presence service, the user terminal 240 can select the locations intending to be serviced from the location list, and feedback the subscriber information including the selection information about the selected location and the user information about the terminal (user ID, password, terminal serial number, terminal model, etc.) to the subscriber managing unit 233. Accordingly, the subscriber managing unit 233 stores the subscriber information provided from the user terminal 240 in the subscriber DB 234, and manages the stored information.

The user terminal 240 using the ubiquitous notification service unit 810 makes a request for the UED appropriate to the specification of the corresponding terminal, if there is no UED file related with the selected location. Accordingly, the user terminal 240 can download the UED file for the user interface from the ubiquitous notification service unit 810; store the UED file in the predetermined memory; and manage the stored UED file.

If there is the UED request from the client of the user terminal 240, the ubiquitous notification service unit 810 can transmit the appropriate UED to the subscriber terminal in consideration of the specification; or can transmit the appropriate UED to the subscriber terminal in consideration of the data type designated by the subscriber through the client.

Through the ubiquitous contents gateway 910, the MO-based contents provided from the ubiquitous subscriber terminal can be frequently uploaded to the application server 220 (S13). Whenever the MO-based upload information or the application information such as log-in information, pop-up information, and blog or on-line community information is frequently changed at the location of presence service, the application server 220 transmits the status information of the corresponding application in real-time, for example, the present or updated status of service such as the real-time stock price, the number of unread e-mails, the new writings or comments in the blog, the title of new writing or comments, the notice writing in the bulletin, and the uploaded contents, to the ubiquitous presence server 230 (S14).

The application server 220 can transmit the updated presence information to the subscriber terminal in real time whenever the presence information is updated, but it is not limited to this. For example, even though the presence information is not updated, the present status of the application information may be periodically transmitted to the subscriber terminal every dawn with less traffic.

Then, the ubiquitous presence server 230 determines whether the corresponding provider and subscriber are valid based on the provider DB 232 and subscriber DB 234. If it is determined that the corresponding provider and subscriber are valid (S15), the received presence information is relayed to the corresponding subscriber terminal.

Among the user terminals 240, the subscriber terminal can receive the presence information of the corresponding location whenever the application information from the application server is changed and updated.

For this, when the ubiquitous notification service unit 810 of FIG. 8 transmits the presence information to the subscriber terminal, the presence gateway 235 of the ubiquitous presence server 230 aforementioned receives the presence information from the application server 220 according to the binary protocol of the data type defined in the UED; and transmits the received presence information to the ubiquitous notification service unit 810. At this time, the presence information can be pushed in the XML type.

When receiving the presence information, the list of subscriber terminals to be provided with the presence information can be received together. Thus, the presence information about the corresponding location according to the subscriber information is transmitted to the user terminal through the broker 820 (S16). The broker 820 can transmit the presence information in the communication method supported by the corresponding terminal such as TCP/IP, SMS, UDP, or P2P by dividing the various types of ubiquitous subscriber terminals.

When transmitting the presence information, the broker 820 can transmit the XML-type data (payload) including the message about the presence information without distinguishing the various types of the subscriber terminals. However, considering the small-scale resources of the subscriber terminal, it is desirable to transmit data including the presence information according to the binary protocol corresponding to the data type of the UED file (see FIG. 9) supported by the corresponding terminal by distinguishing the various types of the subscriber terminals.

In another embodiment of the present invention, if the ubiquitous contents gateway 910 of FIG. 9 transmits the presence information to the subscriber terminal, the presence gateway 235 of the ubiquitous presence server 230 receives the presence information from the application server 220, and transmits the received presence information to the ubiquitous contents gateway 910. At this time, the ubiquitous contents gateway 910 determines the data transmission format of the subscriber terminal with reference to the subscriber DB 234; and selects the UI logic 920 appropriate to the subscriber terminal. Accordingly, any one UI logic 920 supporting the corresponding data transmission format converts the presence information into the data format such as XML, HTML, WAP, or binary format, whereby the data converted according to the communication method of the corresponding subscriber terminal is transmitted (S17).

In another embodiment of the present invention, the presence transmitting unit 236 of the ubiquitous presence server 230 can transmit the presence information provided from the presence gateway 235 to the corresponding terminal by the asynchronous transmission method through the use of the asynchronous transmission means (S18).

The various types of user terminals 240 receive the presence information in the corresponding communication method by the corresponding data format, and display the received presence information in the types of FIGS. 3 to 5 through the user interface.

In the meantime, the user terminal 240 can perform the registration procedure for subscription of the presence service in the ubiquitous presence server 230 through the use of the client of the user terminal 240. The user terminal 240 can transmit the UED request, and receive the corresponding UED from the ubiquitous notification service unit 810. Also, the user terminal 240 linked with the client extracts and analyzes the template through the use of the template parser for parsing the UED file, so that the presence information is displayed in the user interface by the various presence display formats converted based on the template.

The functions used in the method and system disclosed in the present specification can be implemented as computer-readable codes in a computer-readable recording medium. The computer-readable recording medium includes all kinds of recording devices where data that can be read by a computer system are stored. Some examples of a computer-readable recording medium are a ROM, RAM, CD-ROM, magnetic tape, floppy disk and optical data storage device. Further, the recording medium may be implemented in the form of a carrier wave (e.g., transmission through Internet). Further, the computer-readable recording medium is distributed to a computer system connected through a network so that computer-readable codes can be stored and executed in a distributed manner.

As apparent from the above description, according to the ubiquitous presence service method and system of the present invention, the list of subscribers is managed in the relay platform, and the presence of each service from the application server is integrated through one route, and is then integrally managed so that they are provided based on 3A, anytime, anywhere and regardless of the device, whereby the subscriber who receives the information about the present status of the application services operated by the various application servers can integrally manage his\her own presence profiles, and the application server can provide the subscription authorities of the presence service to the consistent interface.

Also, the appropriate broker connection for supporting the data format registered by the application server, the UI logic linked with the predetermined contents gateway, or the asynchronous transmission processor is operated so that any type of ubiquitous user terminal can receive the presence service by the communication method appropriate to the corresponding user terminal.

Further, according to the ubiquitous presence service method and system of the present invention, such technologies are implemented through small modifications of the existing legacy service, so an integrated presence service appropriate for ubiquitous devices can be provided, and ubiquitous connection rings that can be more closely adhered to the service can be provided to the user, thereby significantly contributing the development of the service itself.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A ubiquitous presence service method comprising:
receiving presence information comprising a present status or updated status of an application service from one or more application servers; and
transmitting the received presence information to at least one subscriber terminal.

2. The ubiquitous presence service method of claim 1, wherein the received presence information is transmitted using a communication method supported by the corresponding subscriber terminal based on a type of each subscriber terminal.

3. The ubiquitous presence service method of claim 2, wherein the communication method includes one or more methods of TCP/IP (Transmission Control Protocol/Internet Protocol), SMS (Short Message Service), UDP (User Datagram Protocol), and P2P (Peer to Peer).

4. The ubiquitous presence service method of claim 1, further comprising registering provider information comprising a location list of application information to be the presence service from one or more application servers before receiving the presence information,
wherein receiving the presence information comprises receiving the presence information updated from the location list of the application information from the one or more application servers.

5. The ubiquitous presence service method of claim 1, wherein the received presence information is transmitted using at least one data format of XML (eXtensible Markup Language), HTML (Hyper Text Markup Language), WAP (Wireless Application Protocol), and binary format, supported by the corresponding subscriber terminal based on a type of each subscriber terminal.

6. The ubiquitous presence service method of claim 1, further comprising:
transmitting a location list of application information to be the presence service to a user terminal in response to a request from the user terminal; and
registering user information corresponding to the user terminal and selection information about at least one location selected by a user from the location list of the application information as subscriber information,
wherein transmitting the received presence information comprises transmitting the presence information updated at the corresponding location of the subscriber information.

7. The ubiquitous presence service method of claim 1, wherein the application service includes MO (Mobile Origination)-based service in which the application information to be the presence service is updated according to information uploaded from a user terminal.

8. The ubiquitous presence service method of claim 1, wherein the received presence information is transmitted by an asynchronous transmission method when transmitting the received presence information.

9. A ubiquitous presence service method comprising:
integrating presence information for each application service operated by an application server using a relay platform between the application server and various types of ubiquitous terminals through a single route, and integrally managing the presence information; and
transmitting the presence information in a data format supported by the corresponding terminal to at least one of the terminals registered for a subscription to the presence service to at least one part of the presence information desired to receive.

10. A non-transitory computer-readable storage medium with an executable program stored thereon, which when executed, performs the method of claim 1.

11. A ubiquitous presence service system, comprising:
a presence gateway configured to receive presence information including information about a present status or an updated status of an application service; and
a presence transmitting unit configured to transmit the received presence information.

12. The ubiquitous presence service system of claim 11, wherein the presence transmitting unit is configured to distinguish various types of each subscriber terminal, and transmit the received presence information using a communication method supported by the corresponding subscriber terminal.

13. The ubiquitous presence service system of claim 11, further comprising a provider managing unit configured to register provider information comprising a location list of application information to be the presence service in a database on a computer-readable storage medium, wherein the presence gateway is configured to receive the presence information updated from the location list of the application information from the application server.

14. The ubiquitous presence service system of claim 11, further comprising a subscriber managing unit configured to transmit a location list of application information to be the presence service to a corresponding user terminal in response to a request from the user terminal, and to register user information corresponding to the user terminal and selection information about at least one location selected by a user from the location list of the application information as subscriber information, wherein the presence transmitting unit is configured to transmit the presence information updated at the corresponding location according to the subscriber information.

15. The ubiquitous presence service system of claim 11, wherein the presence transmitting unit comprises:
a ubiquitous notification service unit configured to receive the presence information when the presence information is a previously-designated data format; and
one or more brokers configured to transmit the received presence information to each ubiquitous subscriber terminal,
wherein the broker supporting the transmission of the data format, among the brokers, is configured to transmit the received presence information according to the corresponding communication method of the subscriber terminal.

16. The ubiquitous presence service system of claim 15, wherein the ubiquitous notification service unit is configured to transmit a UED file for a user interface to the subscriber terminal in response to a request of the subscriber terminal; the broker is configured to transmit the received presence information according to a binary protocol of the data format designated in the UED file; and the subscriber terminal is configured to display the received presence information converted into a type based on a template obtained by parsing the UED file.

17. The ubiquitous presence service system of claim 11, wherein the presence transmitting unit comprises:
a ubiquitous contents gateway configured to determine a data transmission format of a subscriber terminal; and
one or more user interface logics configured to transmit the received presence information to each ubiquitous subscriber terminal,
wherein the ubiquitous contents gateway is configured to select any one user interface logic supporting the data transmission of the data format among the user interface logics according to the determination result; and the selected user interface logic is configured to convert the received presence information into the data format to transmit the converted data according to the communication method of the subscriber terminal.

18. The ubiquitous presence service system of claim 17, wherein the user interface logics are configured to receive MO-based contents uploaded from the ubiquitous subscriber terminal.

19. The ubiquitous presence service system of claim 11, wherein the presence transmitting unit comprises an asynchronous transmission processor configured to transmit the received presence information by an asynchronous transmission method.
